(19) United States
(12) Patent Application Publication
(10) Pub. No.: US 2008/0086959 A1
(43) Pub. Date: Apr. 17, 2008

(54) Storm shutter

(76) Inventor: David Michael McNelis, Punta Gorda, FL (US)

Correspondence Address: David M. McNelis, 344 Pessoa St., Punta Gorda, FL, 33983, US

(21) Appl. No.: 11/907,157

(22) Filed: Oct. 9, 2007

Related U.S. Application Data
(60) Provisional application No. 60/852,353, filed on Oct. 17, 2006.

(51) Int. Cl. E06B 3/30; E01F 7/00

(52) U.S. Cl. 52/202

(57) ABSTRACT

A storm shutter for protecting building windows from severe weather. A single size storm shutter fits a wide range of window sizes and configurations and can be easily installed in less than a minute by one person of ordinary strength and skill using no tools of any kind. No assembly is required and there is no damage to home left behind. The shutter includes a foldable hinged panel for covering a window's exterior. A pair of ordinary ratchet tie-down mechanisms have a strap affixed to each end. Each strap then threads through the panel's exterior surface via four slots, wraps 180 degrees around a roller and then threads through the center of an inset track to ultimately connect to a shoe. The shoes, which hold the shutter solidly in place by gripping a window frame with great force, are snugly, yet slidably fitted within the track. The shutter folds to allow easy transport and storage and a flexible exterior handle is provided to enable easy handling. The shutter is ideal for non-professional installation as installation requires simply that an individual position the shutter over a window and hand-crank the ratchet mechanism until the shoes automatically self-adjust and engage the window frame securely.

### FIELD OF THE INVENTION

The present invention relates generally to moveable or removable closures for common openings in building structures.

### BACKGROUND OF THE INVENTION

This invention relates to storm shutters, which have been widely used for many years to protect glass windows and other openings in buildings from damaging winds, driving rain, and flying debris. Most common storm shutters are comprised of rigid panels secured to a building's exterior using penetrating fasteners and extensive hardware involving invasive and often difficult and time-consuming installation procedures. Also, installation requires some level of skill to perform and requires various tools to execute as assembly, measuring, cutting, drilling and sizing are always necessary. Furthermore, when such panels are removed after a storm has passed, unsightly hardware or damage to the building remains. This damage must then be repaired. Many people simply do not have the tools, time, or the expertise to accomplish the task successfully without professional assistance.

### SUMMARY OF THE INVENTION

In consideration of the problems associated with the known products for protecting windows and other openings during severe weather, it is a primary objective of the invention to provide a shutter that provides excellent protection from storms yet can be installed easily and quickly by practically anyone. The storm shutter requires no prolonged instruction or specialized skill or experience to install. Additionally, installation can be accomplished in about a minute by one person of ordinary strength with absolutely no tools or assembly required.

It is another objective of the present invention to provide a shutter that is robust in it's construction yet lightweight and easy to handle while also providing a closure that is secure and dependable in it's mounting against high winds or debris impact.

It is a further objective of the present invention to provide a shutter of the type described that can be folded for easy transport or storage when not in use.

It is an additional object of the invention to provide unique elements and arrangements thereof in a storm shutter for the purposes described which allow a single size shutter to fit many differently sized windows within a given range. Thus, the storm shutter is simple to manufacture and market and is essentially non-custom.

Briefly, the storm shutter in accordance with this invention achieves the intended objectives by featuring a lightweight yet rigid two-piece panel having two parallel hinged tracks which span nearly the entire panel lengthwise. Two shoes, each having a load-distributing plate and a resilient pressure pad for gripping a window frame or sill, are slidably installed in each track. A strap is attached to the base of each shoe inside the track and extends within the track to a slot where it passes around a smooth roller to the exterior of the panel where each strap is connected to a common ratchet tie down mechanism on the exterior of the panel. A rigid slide in the center of each track locks the shutter in the open position by tightening two thumbscrews. An impact resistant window is permanently affixed in each piece of the panel to allow natural light inside a building even when the shutter is installed. A flexible handle is attached to shutter's exterior side for ease of handling.

The foregoing and other objects, features, and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a front exterior view of a the shutter in accordance with the present invention shown secured to an exterior window frame.

FIG. 2 is a side view of the shutter shown in FIG. 1 (flexible handle omitted for clarity).

FIG. 3 is an enlarged side view showing details of the center portion hinge and slide area (flexible handle omitted for clarity).

FIG. 4 is an enlarged partial side view showing additional detail including the route of the strap leading from the base of the shoe, through the inside of the track, around the roller and exiting through the exterior slot leading to the ratchet tie-down mechanism (not pictured) on the shutter's exterior.

FIG. 5 is an enlarged end-on profile view intended to show detail of a shoe fitted snugly, yet slidably, inside a track (the flexible handle, locking slide, and thumbscrews are omitted for clarity).

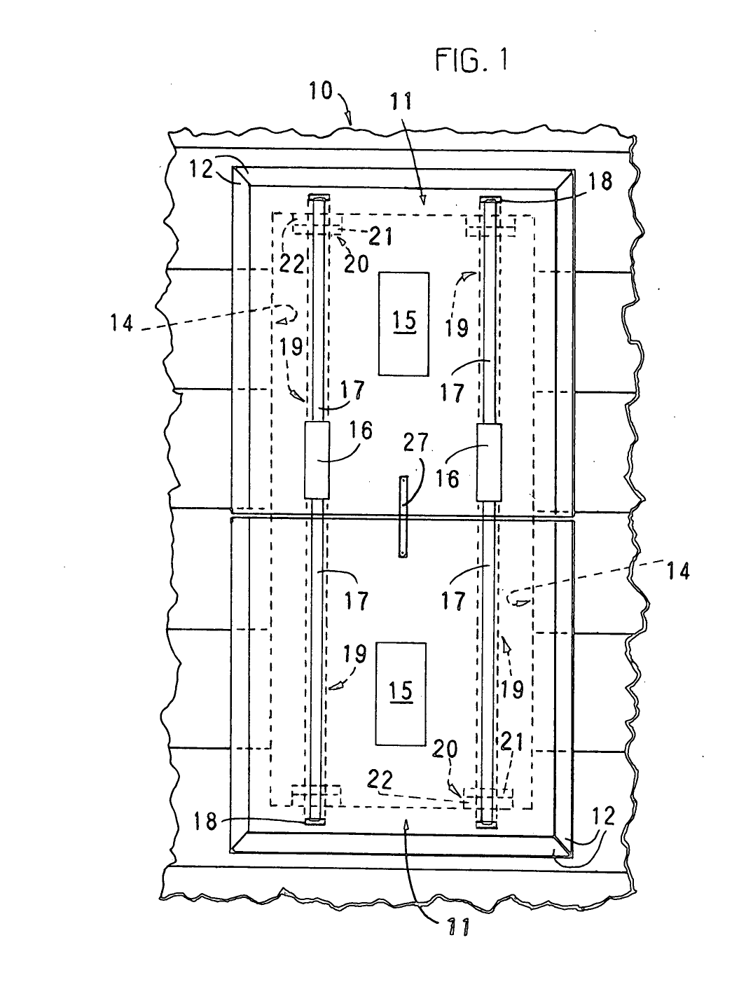

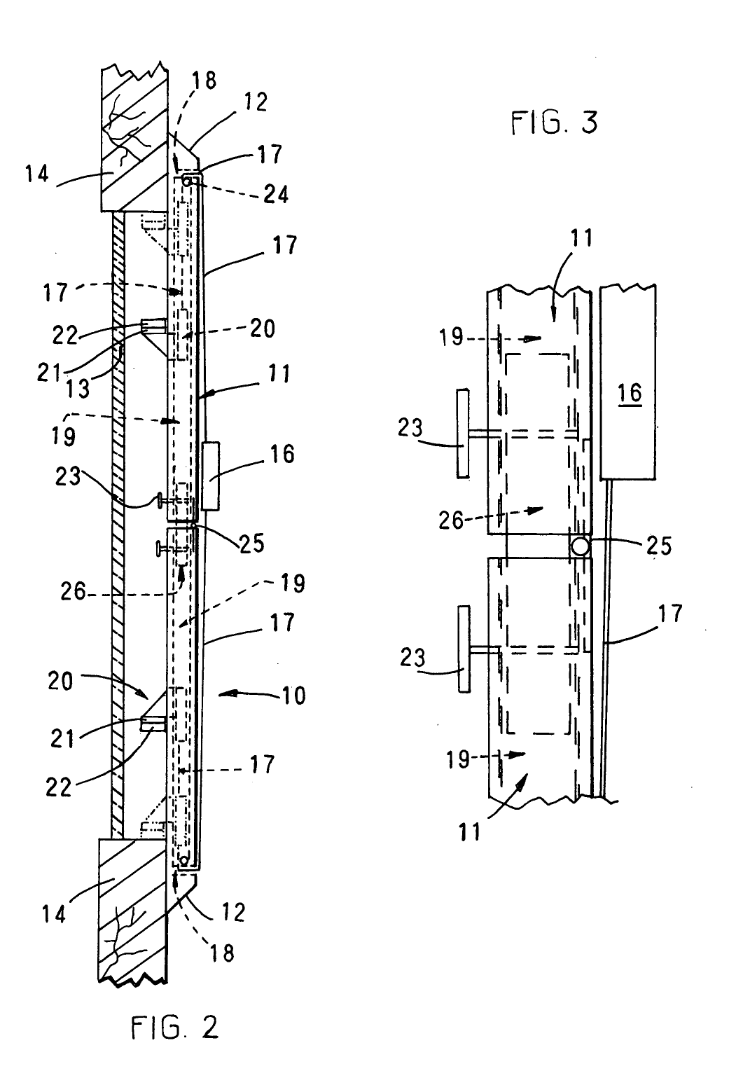

Similar reference numerals denote corresponding features consistently throughout the accompanying drawings.

### REFERENCE NUMERALS

10 storm shutter
11 storm shutter panel
12 beveled peripheral edge
13 window
14 window frame
15 shutter window
16 common ratchet tie-down mechanism
17 strap
18 slot
19 track
20 shoe
21 load distributing plate
22 resilient pad
23 thumbscrew
24 roller
25 hinge
26 locking slide
27 flexible handle

### DETAILED DESCRIPTION AND OPERATION OF THE PREFERRED EMBODIMENT

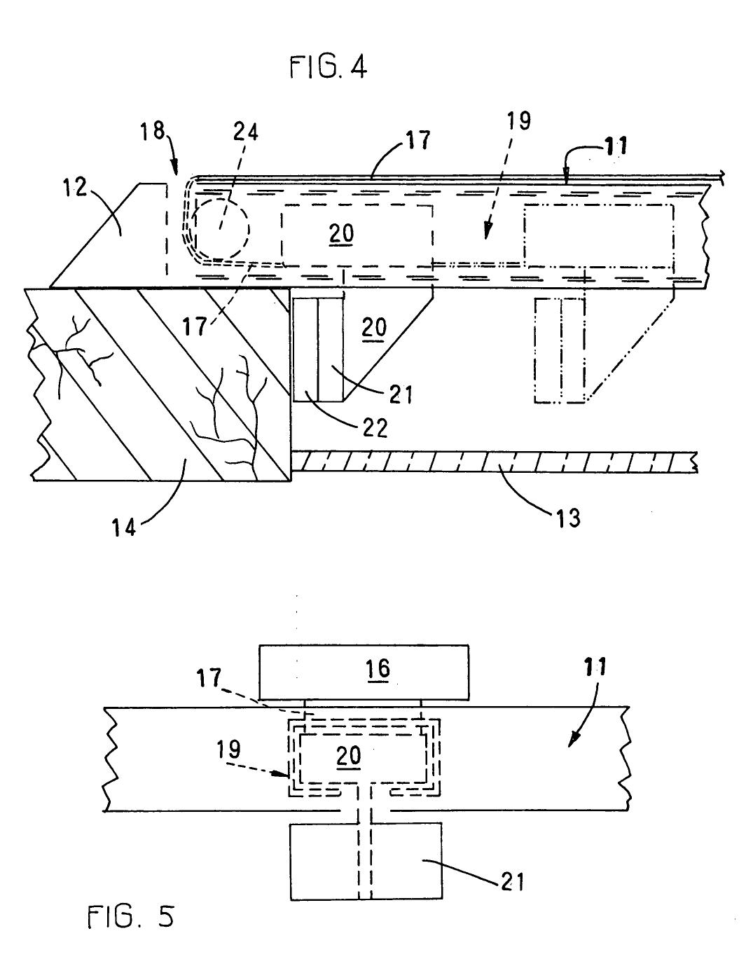

Referring now to the FIGS., a shutter in accordance with the invention is shown at 10. The shutter 10 includes a hinged panel 11 that covers a window 13 supported by a window frame 14. A pair of common ratcheting tie-down mechanisms 16 have a strap 17, connected to each end. Each strap 17, is threaded through one of four dedicated slots 18, which perforate panel's 11 exterior surface. Each strap 17 then wraps 180 degrees around roller 24 and enters the open end of each “C” shaped track 19 and runs (nestled inside of track 19) to ultimately terminate where it (strap 17) connects to a shoe 20. The tracks 19 are hinged 25 in the middle and inset into interior side of panels 11. A plurality of shoes 20, each consisting of a “T” shaped base (best seen in FIGS. 4 and 5), a load distributing plate 21, and a resilient pressure pad 22 are snugly, yet slidably fitted within track 19 and are attached to each end of strap 17. A flexible strap handle 27 is provided to enable easy handling of the shutter 10.

Panel 11 can be made of almost any rigid material of sufficient strength capable of withstanding high winds and high-speed impact of flying debris, yet injection molded UV light resistant plastic would be superior due to it's high strength-to-weight ratio and low manufacturing cost. The dimensions and shape of panel 11 are a matter of design choice, but, as most windows and window frames are commonly rectangular in shape, panel 11 is provided with a similar shape. In addition, to reduce lateral wind loads, panel 11 is provided with a beveled peripheral edge 12.

The tracks 19 can be made of a variety of material, yet for matters of durability, strength, and rigidity, metal is superior. The shoes 20 (with the exception of the resilient pressure pads 22 that are made of rubber composite) should be made of similar material to the tracks 19 for similar reasons. Each strap 17 is preferably made of nylon for its strength and UV light resistant characteristics.

Further details and descriptions of the preferred embodiment are best described while discussing the normal operation of the invention, which is straightforward and simple.

First, when window 13 (or other opening) protection is desired, shutter 10 is removed (as a complete unit) from its storage place in a garage, under a bed or similar space and placed next to the exterior of window 13. Next, the user visually examines the window 13 to be covered and estimates its size and decides whether the shutter 10 will be mounted vertically or horizontally based upon the overall orientation of window 13. All that is required is that the overall dimension of the widow 13 lies within the overall dimension of the shutter 10.

Next, the shoes 20, which slide freely within tracks 19, are positioned by hand to a point on tracks 19 that lies anywhere within the overall dimension of window frame 14 where shutter 10 is to be mounted. Then, shutter 10 is lifted by its handle 27 and positioned so that the panel 11 covers the window 13 and the shoes 20 are inside the window frame 14. Now, the user simply cranks the handle of either common ratchet tie-down mechanism 16 in the normal manner, thereby causing the strap 17 to be taken in, which in turn pulls the shoes 20 increasingly closer to the window frame 14, eventually engaging the window frame 14 tightly and with great force. The procedure is then repeated using the second ratchet tie-down mechanism 16. This entire installation procedure takes less than a minute to complete.

To remove the shutter 10, each ratchet tie-down mechanism 16 is simply released in the normal manner using its built-in release lever. This instantly releases the tension placed on the shoes 20 and the shutter 10 is disengaged from the window frame 14.

Several key unique elements that provide the shutter 10 its versatility and ease of use and must be addressed when being built:

A) the overall size of the panels 11 should be sufficiently large enough to cover a wide range of window 13 sizes when shutter 10 is unfolded, yet not be so large that ease of handling or storage is compromised. Because the panels 11 cover the window 13 from outside the window frame 14, it does not matter if they overlap a smaller window 13 by a large margin or a larger window 13 by smaller margin. Either way, large or small windows 13 are protected by a single size shutter 10. Two or more shutters 10 can be used simultaneously to protect very large windows.

B) because the shoes 20 grip the inside of the window frame 14, their position, which is essentially determined by the tracks 19 they slide in, should be somewhat narrow to accommodate smaller windows 13. However, they should be spaced sufficiently wide enough to resist twisting forces and provide a firm foundation for the shutter 10.

C) the tracks 19 should extend nearly the entire length of the shutter 10 to provide the maximum distance of travel for the shoes 20. Thus, a single size shutter 10 will accommodate a wider range of window 13 sizes.

### Advantages, Ramifications, and Scope

Accordingly, the reader will see that the shutter of this invention offers unique advantages in that:

it requires no tools of any kind for installation;

it requires no user assembly prior to installation;

it can be easily installed in less than a minute by one person;

it causes no damage to a home nor does it leave unsightly hardware behind;

it provides both the consumer and shutter manufacturer the advantages of requiring few sizes to fit a wide range of window sizes;

it provides a viable method for non-mechanically inclined, elderly, or infirm persons to protect their home in an emergency in the event of a storm; and

it provides the consumer with a shutter that can move with them as they move from one home to another due to the shutter's non-custom properties.

Although the description above contains many specificities, these should not be construed as limitations on the scope of the invention, but rather as an exemplification of one preferred embodiment thereof. Many other variations are possible. For example:

panels 11 can be made in various lengths, depths, widths, shapes. The panels can also be alternatively hinged (vertically or horizontally) as well as have extensions that attach to the main panel(s) in order to alter their shape or size. A single panel or several can be utilized to comprise a single shutter. The panels can also be made of various materials including plastic composites, aluminum, Kevlar, fiberglass, or wood.

tracks 19 may be made in various lengths, depths, widths, and configurations—circular, square, rectangular, or polygonal—with or without offsets and indentations. The tracks can be made of various metals and metal alloys. The tracks can be offset or mounted on the surface of the shutter. Additionally, any number of tracks can be utilized.

shoes 20 can be made in various sizes, shapes, widths, and configurations as long as they fit snugly and remain free to slide in the track(s) 19. Alternatively, the base of the shoes can fit externally around the tracks rather than inside the track(s) as the preferred embodiment exhibits. Shoes can be made of various metals and metal alloys. Also, any number of shoes can be utilized.

resilient pads 22 can be composed of rubber, rubber-composite, or any other durable resilient material.

locking slides 26 can be made of any strong and durable material and can be solid or hollow. They can be omitted entirely if self-locking type hinges 25 are utilized.

ratchet tie-down mechanisms 16 are very common and are available in dozens of sizes, strengths, and configurations and most can be successfully used as part of the shutter 10. In fact, almost any type of ratcheting tie-down mechanism or basic winch mechanism can be utilized as the device that applies the force to the shoes 20. Additionally, any number of ratcheting mechanisms can be used, but more than two would be counter-productive.

straps 17 can be any length, width, or thickness and made of any strong material, including chain or steel cable, depending on what type of ratchet tie-down or basic winching mechanism is used. The key factor is that the straps must be flexible enough to reverse direction 180 degrees in order to thereby reverse the force provided from the ratchet tie-down mechanism 16.

Therefore, it is to be understood that the present invention is not limited to the sole embodiment described and illustrated above, but encompasses any and all embodiments within the scope of the appended claims and their legal equivalents.

I claim:

1. A storm shutter, comprising:
a panel for covering a window, said panel having a pair of slots;
a track being affixed to said panel;
a pair of shoes, slidably connected to said track, for gripping a window frame;
a common ratchet tie-down mechanism; and,
a pair of straps connecting said common ratchet tie-down mechanism to said shoes via said slot.

2. A storm shutter, comprising:
a panel for covering a window, said panel having a plurality of parallel slots;
a plurality of parallel tracks being affixed to said panel;
a plurality of shoes, slidably connected to said tracks, for gripping a window frame;
a plurality of common ratchet tie-down mechanisms; and,
a plurality of straps connecting said common ratchet tie-down mechanisms to said shoes via said slots so that said common ratchet tie-down mechanisms can convey force to said shoes thereby causing said shoes to slide within said tracks.

3. A storm shutter according to claim 2 wherein said ratchet tie-downs are accessible on exterior side of said panel and said shoes extend from interior side of said panel.

4. The storm shutter according to claim 2 wherein said panel has a beveled peripheral edge for reducing wind loads.

5. The storm shutter according to claim 2 wherein each said shoe includes a load-distributing plate being affixed to said shoe and a resilient pad is affixed to said load-distributing plate.

6. The storm shutter according to claim 2 wherein said panel has at least one built-in impact-resistant window incorporated so that natural light may enter building when said storm shutter is installed.

7. The storm shutter according to claim 2 wherein said panel is hinged thereby allowing said panel to be folded for easy transport and storage.

8. The storm shutter according to claim 2 wherein each of said tracks comprises a lengthwise slotted tube having a polygonal cross section and each of said shoes has a corresponding cross section for preventing relative rotation.

9. The storm shutter according to claim 2 further comprising a plurality of locking slides, each slidably connected to said tracks, for locking said panel in the open position.

10. The storm shutter according to claim 9 wherein said locking slides are threadably engaged with, and penetrated by, a plurality of thumbscrews which can be driven into said tracks thereby facilitating the locking of said panel in the open position.

11. The storm shutter according to claim 2 further comprising a plurality of rollers inset into the outer ends of said tracks for facilitating the smooth passage of said straps around the outer ends of said tracks to said shoes.

12. The storm shutter according to claim 2 wherein said panel's exterior surface is equipped with a flexible handle so that said storm shutter can be easily handled.

13. A storm shutter, comprising:
a panel for covering a window, said panel including:
a plurality of parallel slots;
a plurality of hinges so that said panel can fold for easier transport and storage;
at least one flexible handle so that storm shutter can be easily handled; and,
at least one built-in impact-resistant window incorporated so that natural light may enter building when said storm shutter is installed; and,
a plurality of parallel tracks being affixed to said panel, each track including:
a roller inset into the outer ends of said track; and,
a plurality of shoes, slidably connected to said tracks, for gripping a window frame, each shoe including:
a load distributing plate;
a resilient pad affixed to said load-distributing plate; and,
a plurality of common ratchet tie-down mechanisms so that amplified force can be applied, by hand, to said shoes so that said shoes can grip a window frame with great force;
a plurality of straps connecting said common ratchet tie-down mechanisms to said shoes via said slots so that said common ratchet tie-down mechanisms can convey force to said shoes thereby causing said shoes to slide within said tracks to engage a window frame; and,
a plurality of locking slides, each slidably connected to said tracks, for locking said panel in an open position.
